(19) United States
(12) Patent Application Publication
(10) Pub. No.: US 2026/0135445 A1
(43) Pub. Date: May 14, 2026

(54) MODULAR MOTOR AND CONTROLLER ASSEMBLY

(71) Applicant: REV Robotics LLC, Carrollton, TX (US)

(72) Inventors: Gregory Needel, Coppell, TX (US); David Yanoshak, Dallas, TX (US); Orion DeYoe, Irving, TX (US); Francisco Lima, Carrollton, TX (US); Marcos Lima, Lewisville, TX (US); Jerray Dewa, Carrollton, TX (US); Noah Andrews, Carrollton, TX (US); Jan-Felix Abellera, Dallas, TX (US); Freddy Aguinaga, Irving, TX (US); Landry Norris, Princeton, TX (US); Aidan Rudy, Richardson, TX (US)

(21) Appl. No.: 18/944,237

(22) Filed: Nov. 12, 2024

(51) Int. Cl. H02K 11/30

(52) U.S. Cl. CPC H02K 11/30; H02K 2211/03; H02K 2213/12

(57) ABSTRACT

A motor controller, motor, and modular motor assembly. The modular motor assembly includes a motor including a rotor rotatably coupled with a stator, and a motor controller removably coupled to the motor at a mating interface. The modular motor assembly defines a through bore passing through the motor and the motor controller which is configured to transfer torque to a removable shaft inserted into the through bore.

### BACKGROUND

### Technical Field

Novel aspects of the present disclosure relate to the field of motors and more particularly to a modular motor and controller assembly.

### Background

Motors convert electricity into physical movement. Motors can be generally classified as AC motors, brushed and brushless DC motors, geared DC motors, servo motors, stepper motors, and DC linear motors. AC motors are generally connected to power mains and used in industrial applications/environments for high torque applications. DC motors are generally connected to batteries and used in applications requiring relatively less torque.

Motor selection requires understanding of application parameters, including power, speed, torque, size, and efficiency, to name just a few. Conventional motors are typically selected based on specific application parameters, which requires end users to purchase different motors for different application parameters. Changing motors requires the end users to uncouple the mechanical and electrical connections to remove the existing motor before installing a different motor.

### SUMMARY

Novel aspects of the present disclosure are directed to a motor controller, a motor, and a modular motor assembly. The modular motor assembly includes a motor having a rotor rotatably coupled with a stator, and a motor controller removably coupled to the motor at a mating interface. The modular motor assembly defines a through bore passing through the motor and the motor controller. The through bore is configured to transfer torque to a removable shaft inserted into the through bore.

The motor controller includes a housing that defines a mating interface. The mating interface includes an electrical connection configured to power a motor coupled to the motor controller at the mating interface. The motor controller also includes a circuit board disposed within the housing. The circuit board includes hardware, such as a microcontroller, for controlling the motor coupled to the motor controller. The motor controller also includes a through bore passing through the mating interface and a surface of the housing opposing the mating interface and is configured to align with a through bore passing through the motor coupled to the mating interface.

The motor includes a rotor rotatably coupled with a stator. The stator is electrically coupled to an electrical connection at a mating interface at an end of the motor. The motor also includes a through bore passing through the rotor and the stator. Further, the through bore is aligned coaxially with an axis of rotation of the rotor and the through bore is configured to transfer torque to a removable shaft inserted into the through bore when the stator receives electricity from the electrical connection.

Other aspects, embodiments and features of the disclosure will become apparent from the following detailed description of the novel aspects of the disclosure when considered in conjunction with the accompanying figures. In the figures, each identical, or substantially similar component that is illustrated in various figures is represented by a single numeral or notation. For purposes of clarity, not every component is labeled in every figure. Nor is every component of each embodiment shown where illustration is not necessary to allow those of ordinary skill in the art to understand the novel aspects of the disclosure.

### BRIEF DESCRIPTION OF THE FIGURES

The novel features believed characteristic of the disclosure are set forth in the appended claims. The disclosure itself, however, as well as a preferred mode of use, further objectives and advantages thereof, will be best understood by reference to the following detailed description of illustrative embodiments when read in conjunction with the accompanying figures, wherein:

FIGS. 1-3 are various views of the modular motor assembly in an assembled configuration according to an illustrative embodiment;

FIGS. 4-6 are various views of the modular motor assembly in a disassembled state in accordance with an illustrative embodiment; and

FIG. 7 is cross-sectional view of the modular motor assembly in an assembled configuration in accordance with an illustrative embodiment;

FIGS. 8-13 are various views of the motor of the modular motor assembly in accordance with an illustrative embodiment;

FIGS. 14-17 are various views of the motor controller of the modular motor assembly in accordance with an illustrative embodiment;

FIG. 18 is a view of a removable shaft in accordance with an illustrative embodiment;

FIGS. 19-24 are various views of a removable shaft in accordance with another illustrative embodiment;

FIGS. 25-30 are various views of a removable shaft in accordance with yet another illustrative embodiment; and

FIGS. 31-36 are various views of a removable shaft in accordance with yet another illustrative embodiment.

### DETAILED DESCRIPTION

Novel aspects of this disclosure recognize the need for providing end users with more flexibility in motor selection. The modular motor assembly disclosed herein also obviates the need for users to fully uninstall a motor assembly in the event that application parameters change. Furthermore, novel aspects of the modular motor assembly also provides more flexibility in the type of shaft driven by the motor.

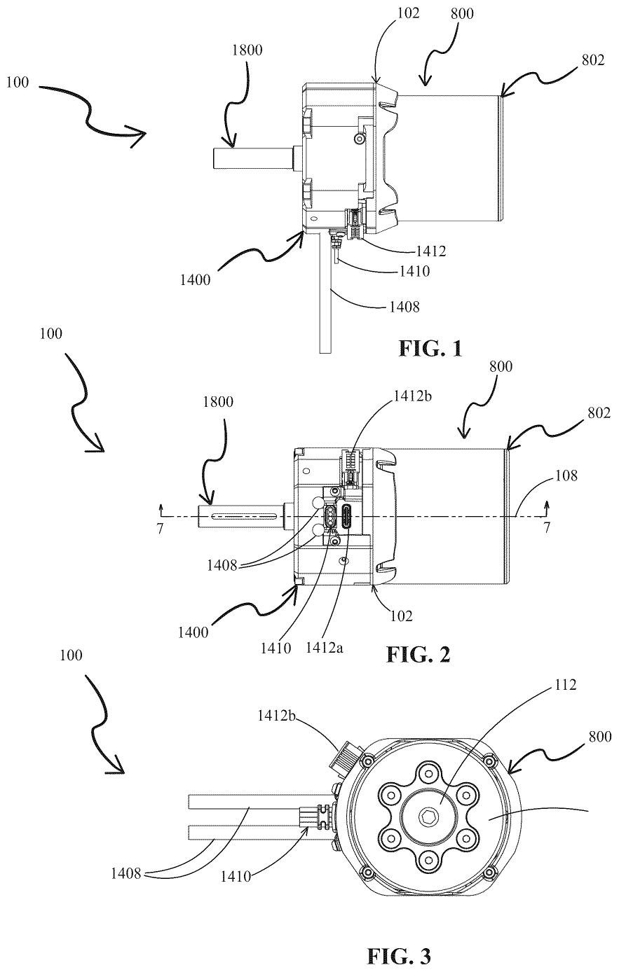

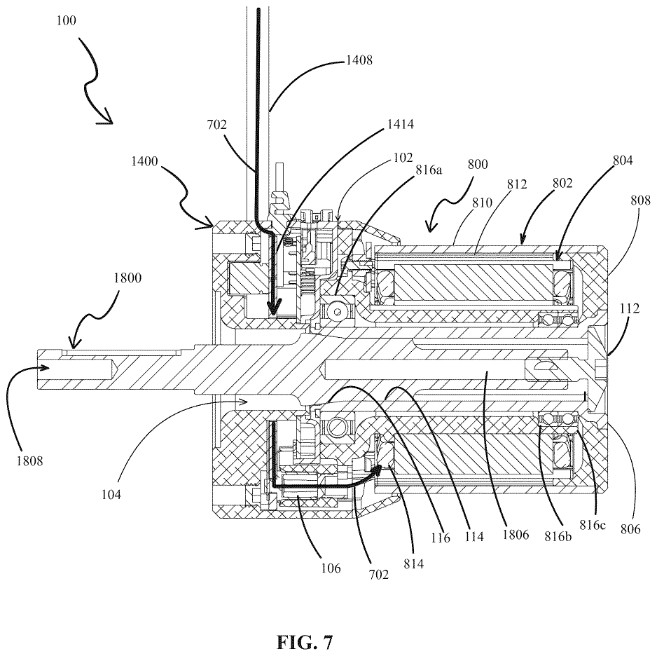

FIGS. 1-3 are various views of the modular motor assembly in an assembled configuration according to an illustrative embodiment. The modular motor assembly 100 is formed generally from a motor controller 1400 connected to a motor 800 at a mating interface 102. The motor 800 includes a rotor 802 rotatably coupled with a stator 804, as can be seen in more detail in the cross-sectional view of the modular motor assembly 100 in FIG. 7. When coupled together, a through bore of the motor controller 1400 and a through bore of the motor 800 form a contiguous through bore 104 passing through the modular motor assembly 100. Restated, the through bore 104 defined by the modular motor assembly 100 is formed from a through bore 104a passing through the motor controller 1400 and a through bore 104b passing through motor 800.

In some embodiments, as shown and discussed in more detail in FIGS. 7, 8, and 18 that follow, the through bore 104 is configured to receive a removable shaft keyed to the geometry of the interior side walls of the modular motor assembly 100 that define the through bore 104 so that the torque generated by the motor 800 can be transferred to the removable shaft. The through bore 104 can include a section having a non-circular transverse cross-section. The non-circular transverse cross-section can be a hexagonal transverse cross-section in a non-limiting embodiment. In addition, or in the alternative, the through bore 104 can also be configured to self-center the removable shaft inserted into the through bore 104. The self-centering capability can be achieved with a second section having a frustoconical taper which transitions into the section having the hexagonal transverse cross-sectional profile, as can be seen in the cross-sectional view of the modular motor assembly 100 in FIG. 7.

The modular motor assembly 100 includes an electrical pathway 702 between a source of electricity (not shown) and a load in the motor 800, e.g., the coils 814 formed from conductive wire. The electrical pathway 702 is represented in FIG. 7 as a series of arrows originating at a set of electrical lines 1408 connecting the modular motor assembly 100 to the source of electricity. The electrical pathway 702 extends through conductive traces in the circuit board 1414, shown generally in FIG. 15, to the electrical connectors 106a embedded in the circuit board 1414 and exposed at the mating interface 102a. The electrical pathway 702 extends through the electrical connectors 106b of the mating interface 102b of the stator 804, and then to coils 814 formed from conductive wire coupled to the electrical connectors 106b. In another embodiment, the set of electrical lines 1408 can be connected directly to the electrical connectors 106a, or to both the electrical connectors 106a and also the circuit board 1414.

As used herein, the term “set” means one or more. Thus, the set of electrical lines 1408 can include two or more electrical lines. In some embodiments, the set of electrical lines 1408 can include three lines, e.g., one for each phase of a three-phase motor.

The circuit board 1414 of the modular controller 1400 is disposed within a motor controller housing 1402. The circuit board 1414 includes hardware and optionally software for controlling the motor 800 using known communications methods, e.g., universal asynchronous receiver/transmitter (UART) or pulse width modulation (PWM). Non-limiting examples of the hardware can include a microcontroller. A bidirectional flow of information can be exchanged between an external computing device and the modular motor assembly 100 through at least one of a set of data ports 1412 and a set of data lines 1410 coupled to the circuit board 1414 and passing through the controller housing 1402. For example, control signals can be provided to the motor controller 1400 from an attached computing device (not shown) based on data transmitted to the computing device from the motor controller 1400. The set of data ports 1412 shown in the exemplary embodiment of this disclosure include a USB-C port 1412a and a serial port 1412b (collectively “set of data ports 1412”) but are non-limiting. Likewise, the set of data lines 1410 shown in the exemplary embodiment of this disclosure include CAN bus cable 1410a and PWM cable 1410b (collectively “set of data lines 1410”).

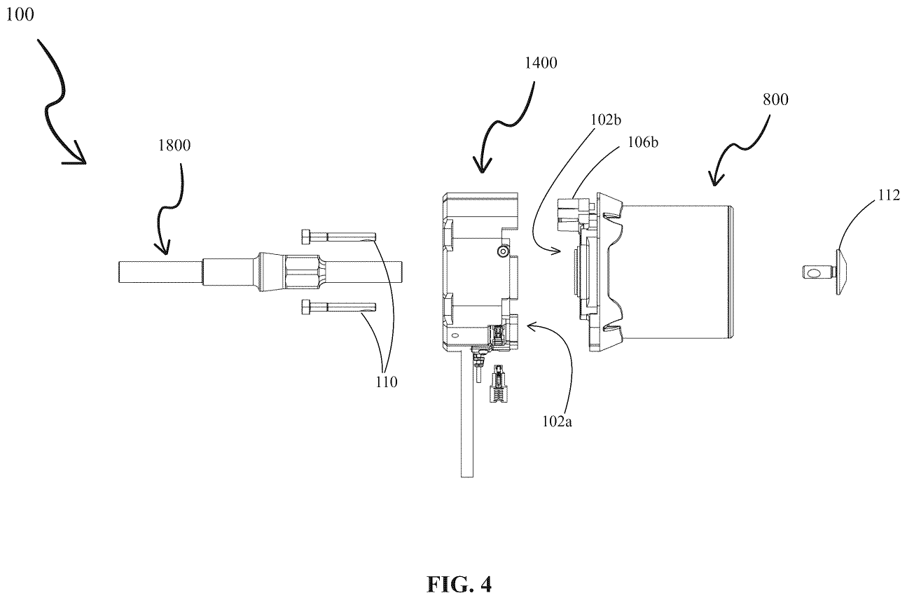

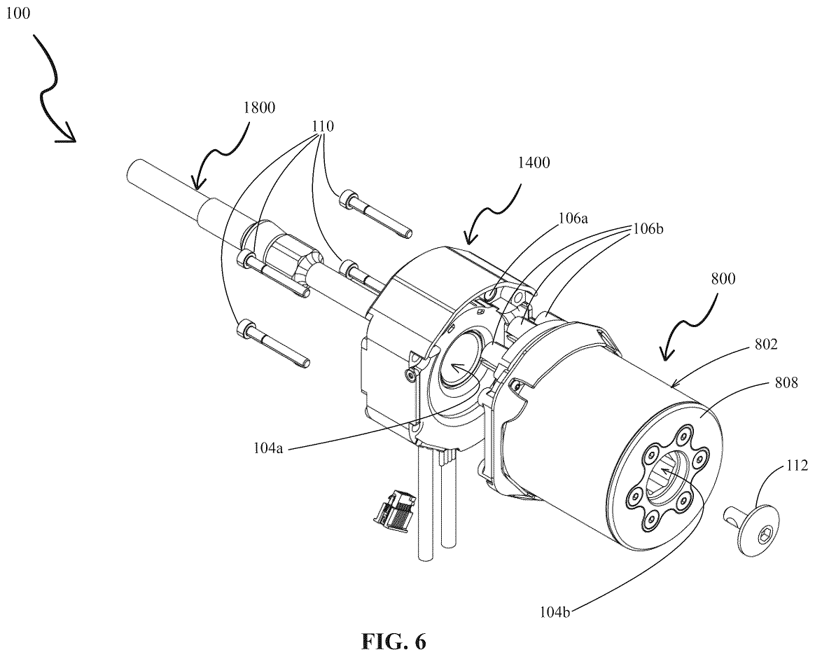

FIGS. 4-6 are various views of the modular motor assembly in a disassembled state in accordance with an illustrative embodiment. The motor controller 1400 is secured to the motor 800 at the mating interface 102 by a set of threaded fasteners 110. The removable shaft 1800 can be inserted into the through bore 104 and seated into the spindle 804 and secured thereto with a draw screw 112. The draw screw 112 can include a flange that engages a terminal end of the spindle 804 or the end wall 808 to secure the removable shaft 1800 to the spindle 804.

FIG. 7 is a cross-sectional view of the modular motor assembly in an assembled configuration in accordance with an illustrative embodiment. The cross-sectional view of the modular motor assembly shown in FIG. 7 is taken along line 7-7 in FIG. 2, which coincides with the axis of rotation 108, and depicts a motor controller 1400 coupled to a motor 800 at a mating interface 102. The coupling of the motor controller 1400 and the motor 800 completes the electrical pathway 702 between the set of power lines 1408 and the load in the motor 800, e.g., the coils 814 formed from conductive wire. Coupling of the motor controller 1400 with motor 800 also joins the through bore 104a of the motor controller 1400 with the spindle through bore 104b of the spindle 806 which forms the through bore 104 of the modular motor assembly 100.

The spindle 806 of the motor 800 is rotatably engaged with the stator 804 by a set of bearings 816. In the illustrative embodiment of this disclosure, the set of bearings 816 includes a first bearing 816a located at or adjacent to the mating interface 102, and at least a second bearing 816b at the end of the stator 804. In the exemplary embodiment depicted in FIG. 7, the set of bearings 816 includes a third bearing 816c adjacent to the second bearing 816b.

Removable shaft 1800 is mounted coaxially within the through bore 104 and seated within the spindle through bore 104b. The removable shaft 1800 can optionally include a blind bore 1806 at its first end 1802 which is configured to receive a draw screw 112 that secures the removable shaft 1800 to the spindle 806. When the removable shaft 1800 is securely seated into the spindle through bore 104b, the tapered section of the removable shaft 1800 engages corresponding tapered section of the spindle through bore 104bb, which allows the removable shaft 1800 to self-center during rotation. The removable shaft 1800 can also have an optional blind bore 1808 at its opposite end 1804, which can be used to secure another object to the end of the removable shaft 1800.

During operation, electricity is provided to the modular motor assembly 100 through the set of power lines 1408. The electricity flows through the electrical pathway 702 that passes through the set of electrical connectors 106 at the mating interface 102 and then flows into the set of coils 814 formed from conductive wire. The flow of electricity, which may be controlled by hardware housed in the motor controller 1400 can cause a rotating electrical field in the motor 800. The rotating electrical field causes the magnets 812, which are disposed on the interior surface of the rotor 800 and adjacent to the set of coils 814, to rotate. The rotation is transferred to the removable shaft 1800 by the spindle 806 riding on the set of bearings 816 exposed on the interior through bore of the stator 804. Data and control signals exchanged with an external computing device via the set of data lines 1410 and/or the set of data ports 1412 can allow the motor controller 1400 to control operation of the motor 800 in a manner that is known to those having skilled in the art.

At least one benefit possessed by the modular motor assembly 100 is the ability for end users to replace one or more components of the modular motor assembly 100 in the event of failure, rather than having to replace the entire modular motor assembly 100. For example, the motor controller 1400 can be replaced separately from the motor 800. In contrast, conventional motor assemblies generally require replacement of the entire motor assembly in the event of failure. Furthermore, the motor controller 1400 can be used to control different motors that have compatible mating interfaces. For example, some applications may require more torque than what is available in the attached motor. The motor controller 1400 can remain mechanically and electrically attached to its existing mounting location while the motor can be replaced with a motor providing the necessary torque.

Another benefit of the modular motor assembly 100 disclosed herein is that it can accommodate a shaft that extends out of the first end 1404 of the motor controller 1400 and the end wall 808 of the motor 800 to drive a target on either end of the modular motor assembly 100. When additional precision is needed, the modular motor assembly 100 can be used with self-centering shaft, such a removable shafts 1800, 1900, 2500, and 3100, which are shown in FIGS. 18, 19, 25, and 31.

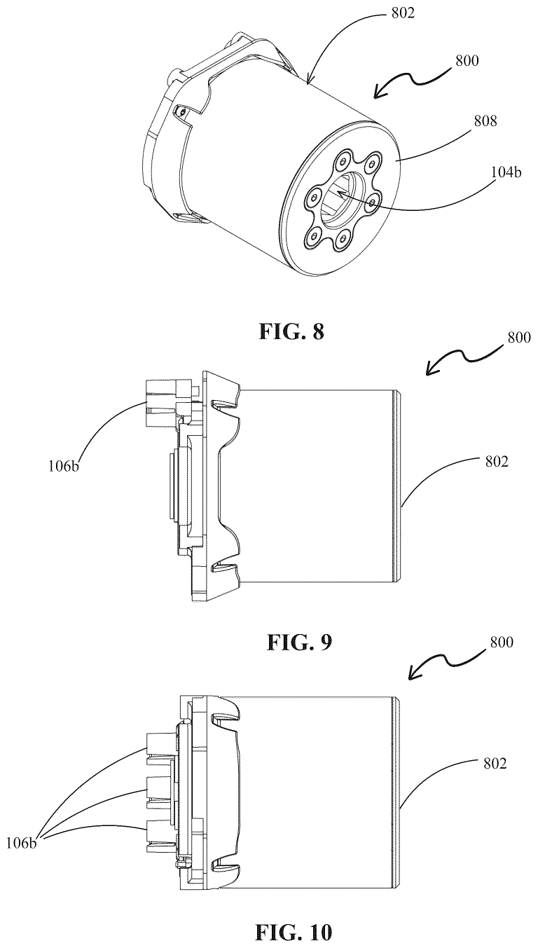

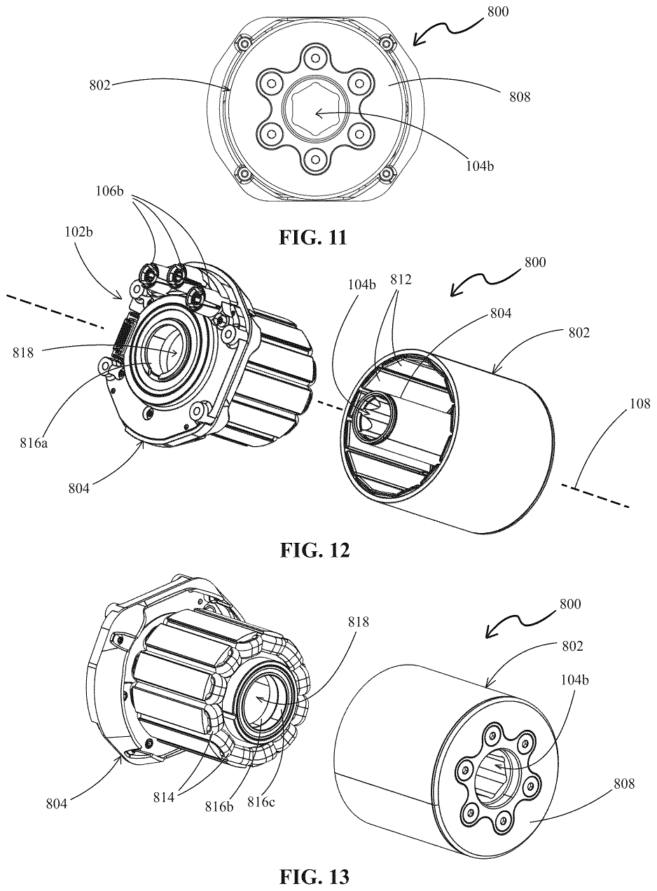

FIGS. 8-13 are various views of a motor of the modular motor assembly in accordance with an illustrative embodiment. In particular, FIG. 8 is a perspective view of the motor 800, FIGS. 9 and 10 are lateral views of the motor 800, and FIG. 11 is a view of an end wall 808 of the motor 800. FIGS. 12 and 13 are perspective views of the motor 800 with the stator 804 separated from the rotor 802.

The motor 800 generally includes a stator 804 that is rotatably engaged with a rotor 802. The exemplary motor 800 of the present disclosure is depicted as an external rotor motor but the motor 800 can be implemented instead as an internal rotor motor. The motor 800 is configured to be removably coupled with a motor controller 1400 at a mating interface 102. In particular, the mating interface 102b of the motor 800 is configured to be coupled to the mating interface 102a of the motor controller 1400.

The rotor 802 includes a spindle 806 attached to end wall 808 that is coupled to or transitions into a side wall 810. In this illustrative embodiment, the side wall 810 is generally cylindrical. Disposed on the interior surface of the side wall 810 is a set of permanent magnets 812 that can interact with the rotating magnetic field induced by the coils 814 of the stator 804. In the exemplary embodiment depicted in this disclosure, the spindle 806 of the rotor 802 is a hollow, cylindrical body that defines a portion of the through bore 104 passing through the modular motor assembly 100 and is oriented coaxially with the axis of rotation 108 of the rotor 802. In particular, the spindle through bore 104b defines the portion of the through bore 104 passing through the motor 800.

The through bore 104 has at least one section 114 that has a non-circular transverse cross-section. In a non-limiting embodiment, the at least one section 114 of the through bore 104 having the non-circular transverse cross-section is defined by the geometry of the interior side wall of the spindle 806, i.e., the geometry of a corresponding section of the spindle through bore 104b. Thus, the spindle 806 has at least one section (corresponding to the at least one section 114 of the through bore 104) having a transverse cross-section where the shape defined by the interior side walls of the spindle through bore 104b is non-circular. The non-circular transverse cross-section of the at least one section 114 allows for a removable shaft to be keyed to the non-circular shape, which allows the removable shaft to mechanically engage the spindle 806 when seated in the spindle through bore 104b. The torque generated by the motor 800 can be passed to the removable shaft by the mechanical engagement of the removable shaft and the spindle 806.

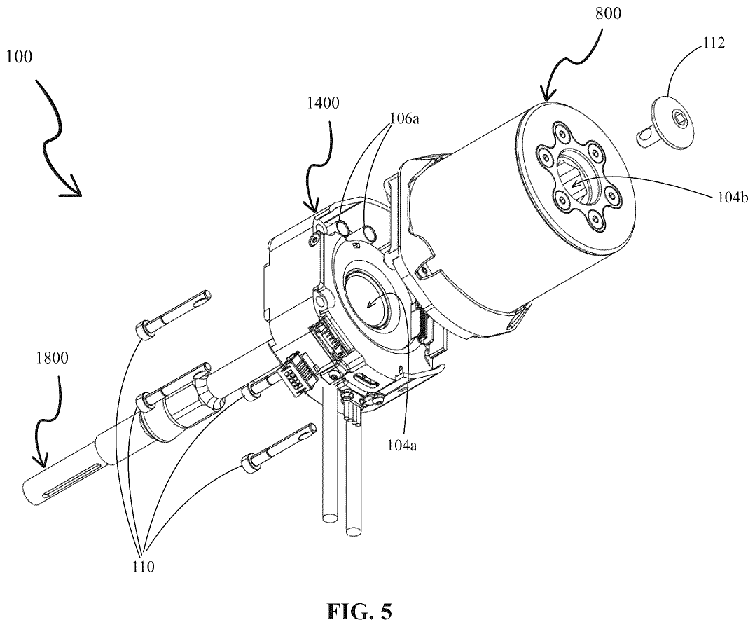

In the non-limiting embodiment depicted in this disclosure, the through bore 104 has a section 114 with a hexagonal transverse cross-section. Thus, the corresponding section of the spindle through bore 104b has interior side walls defining a volume of space with a hexagonal transverse cross-section, as can be seen in FIGS. 5, 6, 8, 11, 12, and 13.

In a non-limiting embodiment, the geometry of the spindle through bore 104b can also be configured to self-center a removable shaft inserted into the spindle 806. For example, the inlet end of the spindle through bore 104b can have a section 116 having a frustoconical taper which can then transition into the section 114 having the non-circular cross-sectional area, e.g., the section of the spindle 806 that has a hexagonal transverse cross-section, as can be seen in the longitudinal cross-section of the spindle 806 shown in FIG. 7. The tapered section of the spindle through bore 104b can engage a taper of a removable shaft, like section 1808 of removable shaft 1800.

The stator 804 includes a plurality of coils 814 formed from conductive wire that are electrically coupled to the electrical connectors 106 at the mating interface 102b. Coupling of the motor 800 and the motor controller 1400 completes the electrical pathway 702 from the source of electricity received by the motor controller 1400 and the load in the stator 804, i.e., the plurality of coils 814. Each of the plurality of coils 814 are spaced apart around a through bore 818 that passes through the stator 804. A set of bearings 816 exposed in the through bore 818 of the stator 804 so that a spindle 806 of the rotor 802 inserted into the through bore 818 engages the set of bearings 816 to cause the rotor 802 to be rotatably engaged with the stator 804.

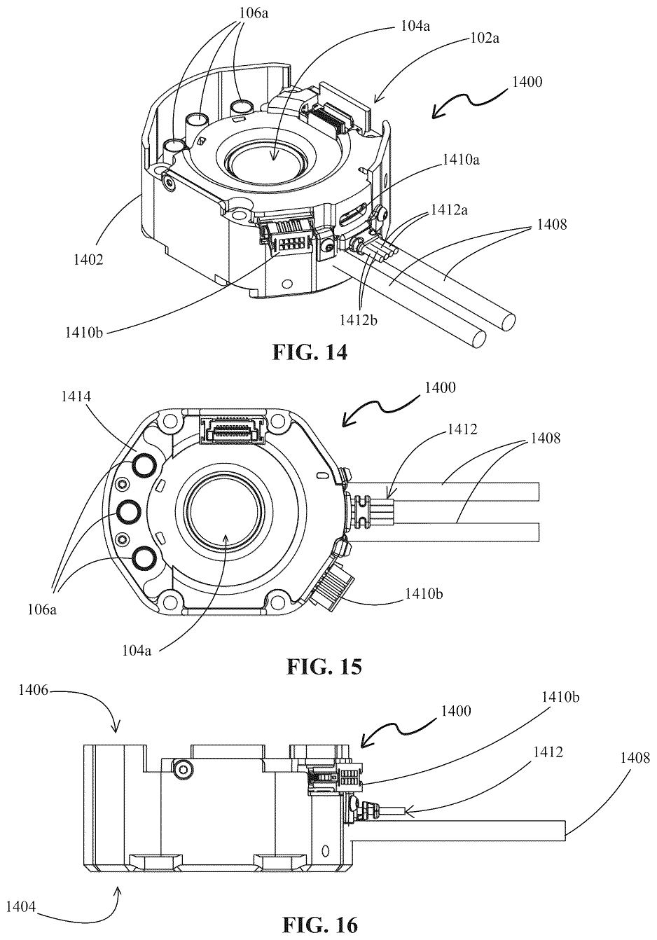

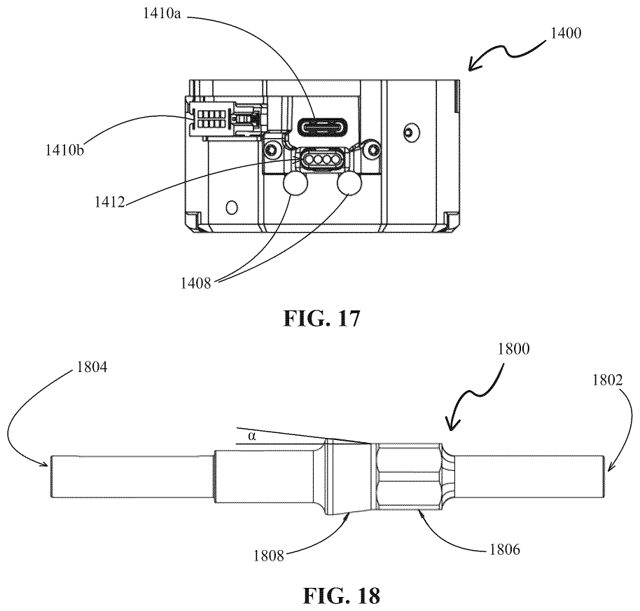

FIGS. 14-17 are various views of the motor controller of the modular motor assembly in accordance with an illustrative embodiment. The motor controller 1400 includes a housing 1402 that has a first end 1404 and an opposite second end 1406, and a through bore 104a passing through the housing 1402 from the first end 1404 to the second end 1406.

The mating interface 102a is located at the second end 1406 of the motor controller 1400. The mating interface 102a includes a set of electrical connectors 106a that are configured to engage the electrical connectors 106b at the mating interface 102b of the motor 800. As previously discussed, disengagement of the motor controller 1400 and the motor 800 at the mating interface 102 separates the connection of the electrical connectors 106, which disrupts the electrical pathway 702.

Extending out from the motor controller housing 1402 are a set of electrical lines 1408 and a set of data lines 1410 for powering the modular motor assembly 100 and facilitating data exchange with an external computing device, respectively. The set of data lines 1410 can include a controller area network (CAN) bus cable 1410a and PWM cable 1410b. Data exchange can also be achieved via the set of data ports 1412 exposed at the outer surface of the motor controller housing 1402. The set of data ports 1412 can include USB-C port 1412a and a serial port 1412b. The set of electrical lines 1408, data lines 1410, and/or data ports 1412 can be coupled to a circuit board 1414 mounted within the housing 1402, along with hardware (not shown) configured to control the operation of the motor 800.

FIG. 18 is a view of a removable shaft in accordance with an illustrative embodiment. The removable shaft 1800 is an elongated member configured to be inserted at least partially through the through bore 104 of the modular motor assembly 100 and seated in the spindle through bore 104b of the rotor 802. At least a portion of the outer surface of the removable shaft 1800 between the first end 1802 and the second 1804 is keyed to the geometry of the inner side wall of the spindle through bore 104b so that rotation of the spindle 806 of the rotor 802 can be transferred to the removable shaft 1800. Thus, the removable shaft 1800 depicted in FIG. 18 has at least a first section 1806 with a hexagonal transverse cross-section to mechanically engage the section of the inner side wall of the spindle through bore 104b that has a corresponding hexagonal transverse cross-section, as shown in FIG. 7 above.

The removable shaft 1800 can also have a second section 1808 with a self-centering taper to engage the tapered section of the spindle through bore 104b. The angle a of the taper of the removable shaft 1800 can be measured relative to a line that is parallel to the axis of rotation 108 and can be between 10-20°, or more particularly, between 12-18°. In a particular embodiment, the taper of the second section 1808 of the removable shaft can be about 15°. The angle of the taper provides sufficient frictional force between the tapered interface of the removable shaft 1800 and the spindle through bore 104b during rotation of the rotor 802 to carry a significant portion of the torque generated by the motor 800. In the event that the torque exceeds the amount of frictional force between the tapered interface, the torque can be transmitted to the first section 1806 of the removable shaft 1800 that is keyed to the geometry of the inner side wall of the spindle through bore 104b.

In a non-limiting embodiment, the hex profile of the first section 1806 of the removable shaft 1800 is 0.5″ nominal flat to flat hexagon with the corners truncated to form a 13.75 mm outer diameter.

In some embodiments, the removable shaft 1800 can be secured to the spindle 806 when the removable shaft 1800 is fully seated in the spindle through bore 104b. In a non-limiting example, the first end 1802 of the removable shaft 1800 can be secured to the spindle 806 with a draw screw 112 that is depicted in FIGS. 3-7.

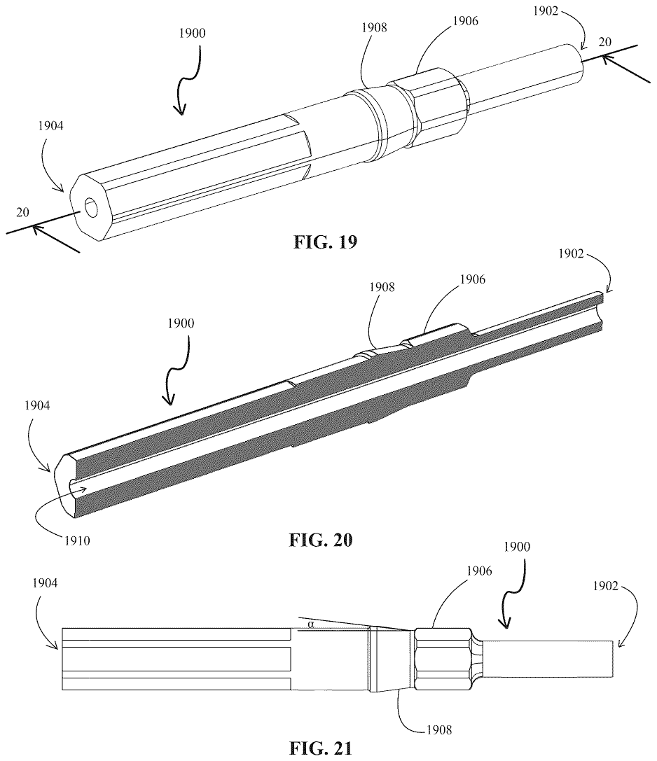

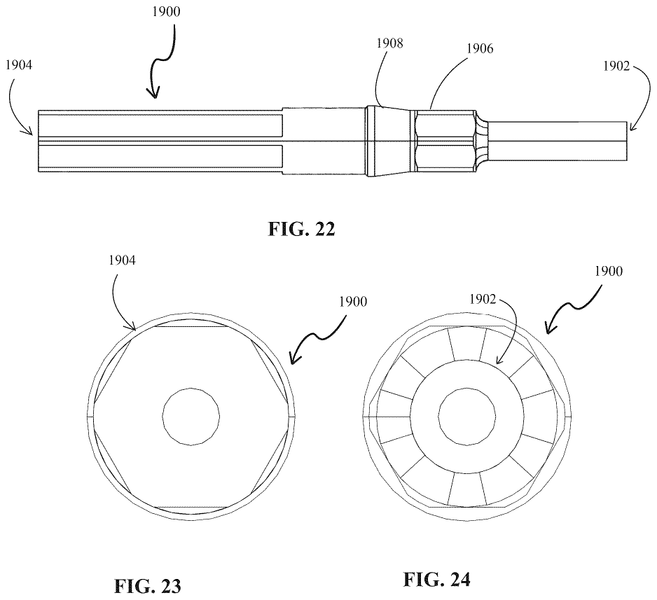

FIGS. 19-24 are various views of a removable shaft in accordance with another illustrative embodiment. In particular, FIG. 19 is a perspective view of the removable shaft 1900; FIG. 20 is a cross-sectional view of the removable shaft taken along lines 20-20 in FIG. 19, which depicts a through bore 1910 extending therethrough; and FIGS. 21 and 22 are lateral views of the removable shaft 1900 but offset by 90 degrees. FIGS. 23 and 24 depict the first end 1902 and the second end 1902, respectively, of the removable shaft 1900.

At least a portion of the outer surface of the removable shaft 1900 between the first end 1902 and the second 1904 is keyed to the geometry of the inner side wall of the spindle through bore 104b so that rotation of the spindle 806 of the rotor 802 can be transferred to the removable shaft 1900. Thus, the removable shaft 1900 depicted in FIG. 19 has at least a first section 1906 with a hexagonal transverse cross-section to mechanically engage the section of the inner side wall of the spindle through bore 104b that has a corresponding hexagonal transverse cross-section, as shown in FIG. 7 above.

The removable shaft 1900 can also have a second section 1908 with a self-centering taper to engage the tapered section of the spindle through bore 104b. The angle a of the taper of the removable shaft 1900 can be measured relative to a line that is parallel to the axis of rotation 108 and can be between 10-20°, or more particularly, between 12-18°. In a particular embodiment, the taper of the second section 1908 of the removable shaft can be about 15°.

When seated in a corresponding spindle through bore 104b, the portion of the removable shaft 1900 exposed outside of the modular motor assembly 100 has a generally hexagonal transverse cross-section.

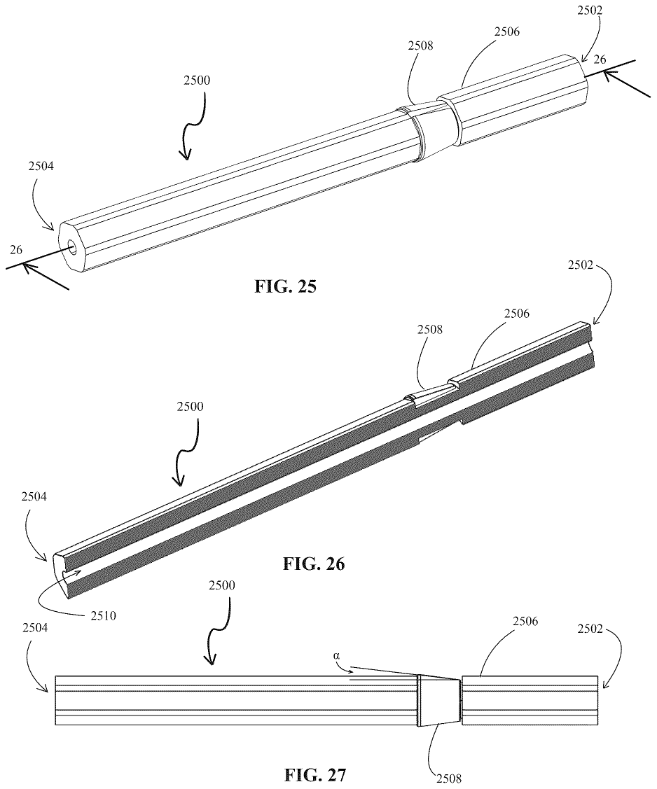

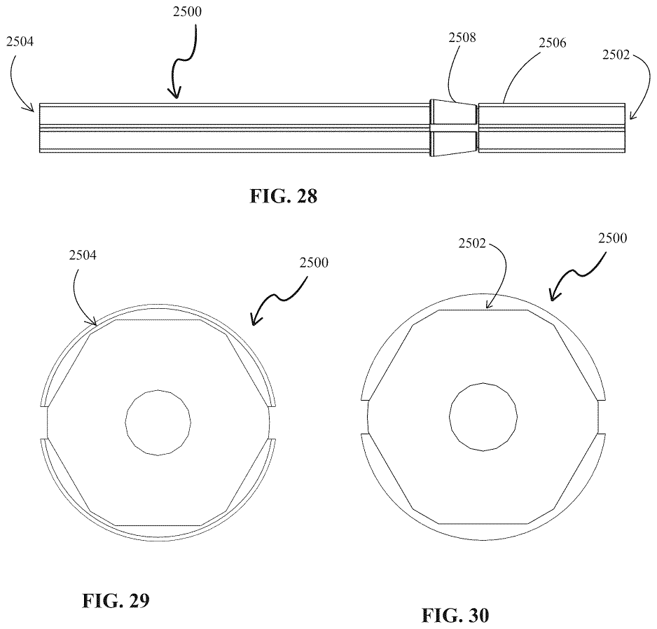

FIGS. 25-30 are various views of a removable shaft in accordance with yet another illustrative embodiment. In particular, FIG. 25 is a perspective view of the removable shaft 2500; FIG. 26 is a cross-sectional view of the removable shaft taken along lines 26-26 in FIG. 25, which depicts a through bore 2510 passing therethrough; and FIGS. 27 and 28 are lateral views of the removable shaft 2500 but offset by 90 degrees. FIGS. 29 and 30 depict the first end 2502 and the second end 2502, respectively, of the removable shaft 2500.

At least a portion of the outer surface of the removable shaft 2500 between the first end 2502 and the second 2504 is keyed to the geometry of the inner side wall of the spindle through bore 104b so that rotation of the spindle 806 of the rotor 802 can be transferred to the removable shaft 2500. Thus, the removable shaft 2500 depicted in FIG. 25 has at least a first section 2506 with a hexagonal transverse cross-section to mechanically engage the section of the inner side wall of the spindle through bore 104b that has a corresponding hexagonal transverse cross-section, as shown in FIG. 7 above.

The removable shaft 2500 can also have a second section 2508 with a self-centering taper to engage the tapered section of the spindle through bore 104b. The angle a of the taper of the removable shaft 2500 can be measured relative to a line that is parallel to the axis of rotation 108 and can be between 10-20°, or more particularly, between 12-18°. In a particular embodiment, the taper of the second section 2508 of the removable shaft can be about 15°.

When seated in a corresponding spindle through bore 104b, the portion of the removable shaft 2500 exposed outside of the modular motor assembly 100 has a generally hexagonal transverse cross-section.

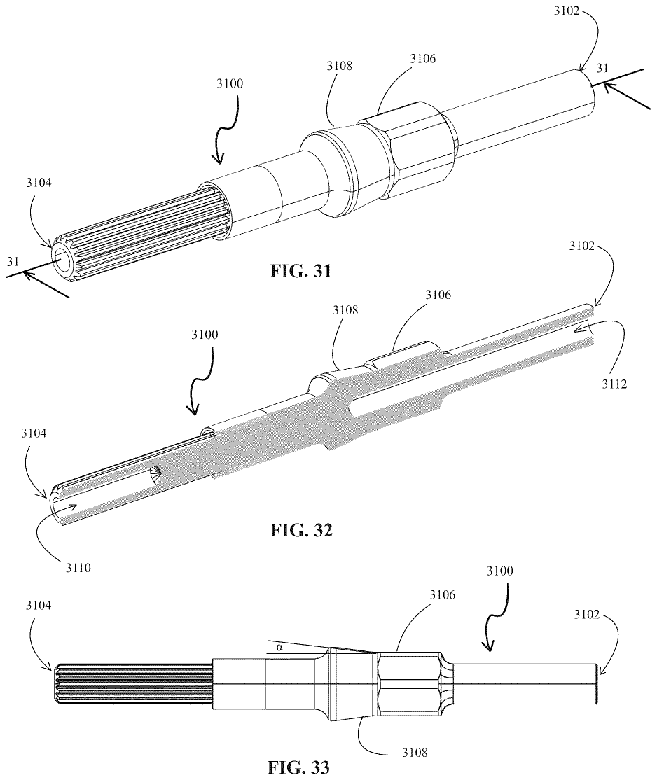

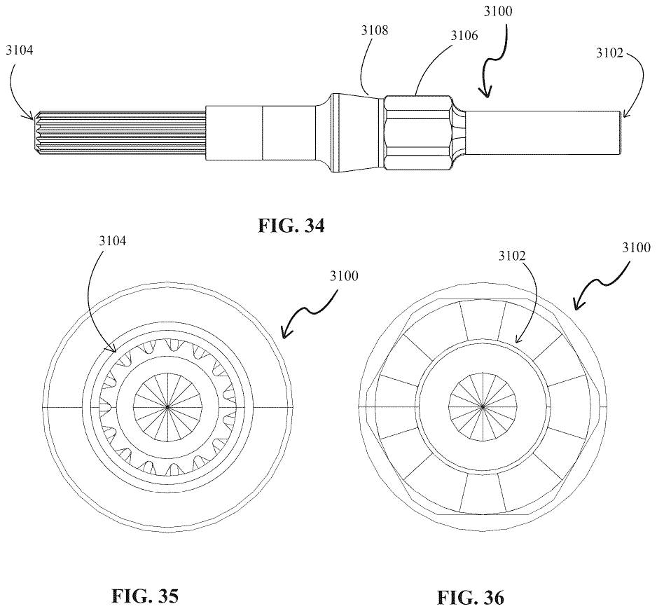

FIGS. 31-36 are various views of a removable shaft in accordance with yet another illustrative embodiment. In particular, FIG. 31 is a perspective view of the removable shaft 3100; FIG. 32 is a cross-sectional view of the removable shaft taken along lines 32-32 in FIG. 31, which depicts a pair of blind bores 3110 and 3112 that may be configured to receive a draw screw; and FIGS. 33 and 34 are lateral views of the removable shaft 3100 but offset by 90 degrees. FIGS. 35 and 36 depict the first end 3102 and the second end 3102, respectively, of the removable shaft 3100.

At least a portion of the outer surface of the removable shaft 3100 between the first end 3102 and the second 3104 is keyed to the geometry of the inner side wall of the spindle through bore 104b so that rotation of the spindle 806 of the rotor 802 can be transferred to the removable shaft 3100. Thus, the removable shaft 3100 depicted in FIG. 31 has at least a first section 3106 with a hexagonal transverse cross-section to mechanically engage the section of the inner side wall of the spindle through bore 104b that has a corresponding hexagonal transverse cross-section, as shown in FIG. 7 above.

The removable shaft 3100 can also have a second section 3108 with a self-centering taper to engage the tapered section of the spindle through bore 104b. The angle a of the taper of the removable shaft 3100 can be measured relative to a line that is parallel to the axis of rotation 108 and can be between 10-20°, or more particularly, between 12-18°. In a particular embodiment, the taper of the second section 3108 of the removable shaft can be about 15°.

When seated in a corresponding spindle through bore 104b, the portion of the removable shaft 1900 exposed outside of the modular motor assembly 100 has a generally circular transverse cross-section from which a plurality of splines extend.

Although embodiments of the disclosure have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

While this disclosure has been particularly shown and described with reference to preferred embodiments, it will be understood by those skilled in the art that various changes in form and detail may be made therein without departing from the spirit and scope of the disclosure. The inventors expect skilled artisans to employ such variations as appropriate, and the inventors intend the novel aspects of the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A modular motor assembly comprising:
a motor including a rotor rotatably coupled with a stator; and
a motor controller removably coupled to the motor at a mating interface, wherein:
the modular motor assembly defines a through bore passing through the motor and the motor controller, and
the through bore is configured to transfer torque to a removable shaft inserted into the through bore.

2. The modular motor assembly of claim 1, wherein:
the modular motor assembly includes an electrical pathway between a source of electricity and a load in the motor; and
decoupling the motor controller from the motor at the mating interface disrupts the electrical pathway.

3. The modular motor assembly of claim 1, wherein the motor controller further comprises:
a set of power wires for providing electricity to the modular motor assembly from the source of electricity.

4. The modular motor assembly of claim 3, wherein the set of power wires for providing the electricity consists of a positive wire and a negative wire.

5. The modular motor assembly of claim 3, wherein the electrical pathway extends from the set of power wires to a detachable coupling at the mating interface and then to the load in the motor.

6. The modular motor assembly of claim 5, wherein the load in the motor comprises the coils of conductive wire.

7. The modular motor assembly of claim 1, wherein the motor controller further comprises a circuit board including hardware for controlling the motor.

8. The modular motor assembly of claim 7, wherein the motor controller further comprises at least one of a set of data ports and a set of data wires coupled to the circuit board.

9. The modular motor assembly of claim 1, wherein the through bore is further configured to self-center the keyed shaft inserted into the through bore.

10. The modular motor assembly of claim 9, wherein the through bore includes a section having a hexagonal transverse cross-sectional profile.

11. The modular motor assembly of claim 10, wherein the through bore includes a second section having a frustoconical taper that transitions into the section having the hexagonal transverse cross-sectional profile.

12. The modular motor assembly of claim 1, wherein the motor is an external rotor motor.

13. A motor controller comprising:
a housing, wherein the housing comprises a mating interface that includes an electrical connection configured to power a motor coupled to the motor controller at the mating interface;
a circuit board disposed within the housing, the circuit board including hardware for controlling the motor coupled to the motor controller; and
a through bore passing through the mating interface and a surface of the housing opposing the mating interface, the through bore configured to align with a through bore passing through the motor coupled to the mating interface.

14. The motor controller of claim 13, further comprising:
a set of electrical lines for providing electricity to the electrical connection at the mating interface.

15. The motor controller of claim 14, wherein the set of electrical lines for providing the electricity consists of a positive wire and a negative wire.

16. The motor controller of claim 13, wherein the motor controller further comprises at least one of a set of data ports and a set of data wires coupled to the circuit board.

17. A motor comprising:
a rotor rotatably coupled with a stator, wherein the stator is electrically coupled to an electrical connection at a mating interface at an end of the motor; and
a through bore passing through the rotor and the stator, wherein:
the through bore is aligned coaxially with an axis of rotation of the rotor; and
the through bore is configured to transfer torque to a removable shaft inserted into the through bore when the stator receives electricity from the electrical connection.

18. The motor of claim 17, wherein the electrical connection is configured to receive the electricity from a motor controller coupled to the motor at the mating interface.

19. The motor of claim 17, wherein the through bore includes a section having a hexagonal transverse cross-sectional profile.

20. The motor of claim 17, wherein the through bore includes a second section having a frustoconical taper that transitions into the section having the hexagonal transverse cross-sectional profile.
